(19) United States
(12) Patent Application Publication
(10) Pub. No.: US 2024/0078415 A1
(43) Pub. Date: Mar. 7, 2024

(54) TREE-BASED SYSTEMS AND METHODS FOR SELECTING AND REDUCING GRAPH NEURAL NETWORK NODE EMBEDDING DIMENSIONALITY

(71) Applicant: Capital One Services, LLC, McLean, VA (US)

(72) Inventor: Michael Langford, Plano, TX (US)

(21) Appl. No.: 17/939,042

(22) Filed: Sep. 7, 2022

(51) Int. Cl. G06N 3/04; G06N 3/08

(52) U.S. Cl. CPC G06N 3/0481; G06N 3/08

(57) ABSTRACT

A method may be provided for selecting embedding dimension, which can include receiving a trained machine learning (ML) model and a graph neural network (GNN) and extracting, from the received ML model, a count of a number of neurons in a penultimate layer and node embeddings for each input graph node in GNN neurons in the penultimate layer. An importance threshold input for filtering the node embeddings can be received, and a tree-based model may be used to return feature importance values. The extracted node embeddings may be input into the tree-based model and an importance metric of each of the node embedding dimensions may be determined from the penultimate layer neurons. The penultimate layer neuron count of the ML model may be restricted to correspond to a number of the highest importance node embedding dimensions and the ML model may be trained using the restricted penultimate layer.

### FIELD

This disclosure generally relates to graph neural network models, and in particular, to extracting importance values for selecting and/or reducing dimensionality of graph neural network node embeddings for downstream models.

### BACKGROUND

Node embeddings from graph neural networks can be incredibly useful for many applications that involve graph data structures. Node embeddings may utilize vectors of numbers which allow graph nodes in very high-dimensional, semi-structured data to be turned into low and constant-dimensional vector representations of the nodes that can also preserve some mathematical relationships between neighboring nodes. Node embeddings from graph neural networks can be passed to downstream machine learning models and applications. Finding the optimal dimensionality of these embeddings can help provide more information-dense embeddings to downstream models and can help to train graph neural networks with less time and computation expenses.

Accordingly, there is a need, for example, for improved systems and methods for selecting and/or reducing graph neural network node embedding dimensionality. Embodiments of the present disclosure are directed to this and other considerations.

### BRIEF SUMMARY

Disclosed embodiments may provide systems and methods for extracting importance values from the tree-based model to determine the importance of each graph node embedding dimension in predicting correct node classifications or target values for selecting and/or reducing the dimensionality of graph neural network node embeddings for downstream models.

Consistent with the disclosed embodiments, a computer-implemented method may be provided for reducing or selecting embedding dimensions in a machine learning model. The method may include receiving a trained machine learning (ML) model, the ML model comprising input graph data, and a graph neural network (GNN) having GNN neurons and associated node embeddings, wherein the node embeddings comprise N scalar values representing features of the GNN identifies for each neuron. The method may include extracting, from the received ML model: a count of a number of neurons in a penultimate layer of the ML model, node embeddings for each input graph node in GNN neurons in the penultimate layer, and scalar values from an output of the ML model. The method may include receiving, as input: an importance threshold input for filtering the node embeddings, and identification of a tree-based model configured to return feature importance values. The method may include inputting, into the tree-based model, the node embeddings extracted from neurons in the penultimate layer of the ML model, and determining, using the tree-based model, an importance metric of each of the node embedding dimensions from the ML model penultimate layer neurons. The determining may include processing the tree-based model, summing node embedding dimension importance value outputs of the tree-based model, and filtering the summed outputs to produce the highest importance node embedding dimensions from the penultimate layer neurons by applying the importance threshold input to the summed outputs. The method may include restricting the penultimate layer neuron count of the ML model to correspond to a number of the highest importance node embedding dimensions and training the ML model using the restricted penultimate layer.

Consistent with the disclosed embodiments, a system may be provided that may include a processor and memory having instructions that when executed by the processor cause the processor to receive a trained machine learning (ML) model that may include input graph data and a graph neural network (GNN) having GNN neurons and associated node embeddings. The node embeddings include N scalar values representing features that the GNN identifies for each neuron. The memory may be configured to instruct the processor to extract, from the received ML model: a count of a number of neurons in a penultimate layer of the ML model, node embeddings for each input neuron in the ML model penultimate layer, and scalar values from an output of the ML model. The memory may be configured to instruct the processor to receive as input, an importance threshold input for filtering the node embeddings, and identification of a tree-based model configured to return feature importance values. The memory may be configured to instruct the processor to input, into the tree-based model, the node embeddings extracted from the neurons in the penultimate layer of the ML model, and determine, using the tree-based model, and an importance metric of each of the node embedding dimensions from the penultimate layer neurons, which may include processing the tree-based model, summing node embedding dimension importance value outputs of the tree-based model, and filtering the summed outputs to produce highest importance node embedding dimensions from the penultimate layer neurons of the ML model by applying the importance threshold input to the summed outputs. The memory may be configured to instruct the processor to restrict the penultimate layer neuron count of the ML model to correspond to a number of the highest importance node embedding dimensions and train the ML model using the restricted penultimate layer.

Consistent with the disclosed embodiments, a non-transitory computer-readable storage medium may be provided that may include a set of instructions that, in response to being executed by a processor circuit, can cause the processor circuit to receive a trained machine learning (ML) model that may include input graph data. and a graph neural network (GNN) having GNN neurons and associated node embeddings. The node embeddings may include N scalar values representing features that the GNN identifies for each neuron. The non-transitory computer-readable storage medium may be configured to instruct the processor circuit to extract, from the received ML model: a count of a number of neurons in a penultimate layer of the ML model, node embeddings for each neuron in the ML model penultimate layer, and scalar values from an output of the ML model. The non-transitory computer-readable storage medium may be configured to instruct the processor circuit to receive as input, an importance threshold input for filtering the node embeddings, and identification of a tree-based model configured to return feature importance values. The non-transitory computer-readable storage medium may be configured to instruct the processor circuit to input, into the tree-based model, the node embeddings extracted from the neurons in the penultimate layer of the ML model, and determine, using the tree-based model, and an importance metric of each of the node embedding dimensions from the penultimate layer neurons, which may include processing the tree-based model, summing node embedding dimension importance value outputs of the tree-based model, and filtering the summed outputs to produce highest importance node embedding dimensions from the penultimate layer neurons by applying the importance threshold input to the summed outputs. The non-transitory computer-readable storage medium may be configured to instruct the processor circuit to restrict the penultimate layer neuron count of the ML model to correspond to a number of the highest importance node embedding dimensions, and train the ML model using the restricted penultimate layer.

Further features of the disclosed design and the advantages offered thereby are explained in greater detail hereinafter regarding specific embodiments illustrated in the accompanying drawings, wherein like elements are indicated to be like reference designators.

### BRIEF DESCRIPTION OF THE DRAWINGS

Reference will now be made to the accompanying drawings, which are not necessarily drawn to scale, and which illustrate various implementations and aspects of the disclosed technology and, together with the description, serve to explain the principles of the disclosed technology.

FIG. 1 is an example graph neural network, according to an exemplary implementation of the disclosed technology.

FIG. 2 is an example spreadsheet representation of records (rows) with associated inputs (monthly income, zip code, transaction amount) and determined results (fraud or not), according to an exemplary embodiment of the disclosed technology.

FIG. 3 is an example tabular format representation of a graph neural network, in accordance with certain exemplary implementations of the disclosed technology.

FIG. 4. illustrates simplified hardware and software components that may be utilized in certain exemplary implementations of the disclosed technology.

FIG. 5 is a block diagram of a computing device that may be utilized in the system, in accordance with certain example implementations of the disclosed technology.

FIG. 6 is a flow diagram of a method, according to an exemplary implementation of the disclosed technology.

### DETAILED DESCRIPTION

Training neural networks using high-dimensional data can pose a major technical problem in that high-dimensional data can greatly increase the number of input layer neurons and associated weights, often making the training and computations infeasible. The disclosed technology can provide a solution to this technical problem, for example, by reducing the embedding dimensionality to manageable size, after which, the neural network may be trained and/or utilized using reduced dimensions, which may improve processing speeds and/or may reduce computing resources needed. The disclosed technology may include systems and methods for selecting a lower dimensionality of graph neural network node embeddings to supply dense embeddings for downstream models.

It is intended that each term presented herein contemplates its broadest meaning as understood by those skilled in the art and may include all technical equivalents, which operate similarly to accomplish a similar purpose.

Ranges may be expressed herein as from “about” or “approximately” one particular value and/or to “about” or “approximately” another particular value. When such a range is expressed, another embodiment may include one particular value in the range to another particular value in the range. Similarly, values may be expressed herein as “about” or “approximately.”

The terms “comprising” or “containing” or “including” means that at least the named element, material, or method step is present in the apparatus or method, but does not exclude the presence of other elements, materials, and/or method steps, even if the other elements, materials, and/or method steps have the same function as what is named.

The term “exemplary” as used herein may be intended to mean “example” rather than “best” or “optimum.”

Throughout this disclosure, the terms “node” or “nodes” may be used when referring vertices associated with a graph data structure of graph neural network (GNN). The terms “neuron” or “neurons” may be used when referring to vertices associated with a neural network (such as a machine learning model). A graph data structure of a GNN may be made of nodes (which, for example, may represent merchants) connected by edges (which, for example, may represent monetary transfer between merchants), whereas a neural network may be made of neurons and connections between them which may allow information to flow through the network. In certain implementations, the neurons may have certain associated weights and/or functions.

In accordance with certain exemplary implementations of the disclosed technology, a GNN may be utilized to learn patterns in the graph data. In certain exemplary implementations, after the associated neural network is trained to learn these patterns, encoding values in a penultimate layer of neurons in the neural network can be extracted to provide information about how the neuron encodes a single graph node. In certain exemplary implementations, these values may be expressed vector denoted a (graph) node embedding. In accordance with certain exemplary implementations of the disclosed technology, the node embeddings may be ranked, sorted, filtered, etc., to determine the influence that a particular neuron in the penultimate layer has on influencing the output (i.e., importance value). In certain exemplary implementations, the dimensionality of the machine learning model may be selected and/or reduced based on such information, for example, to provide a more efficient and compact representation.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive.

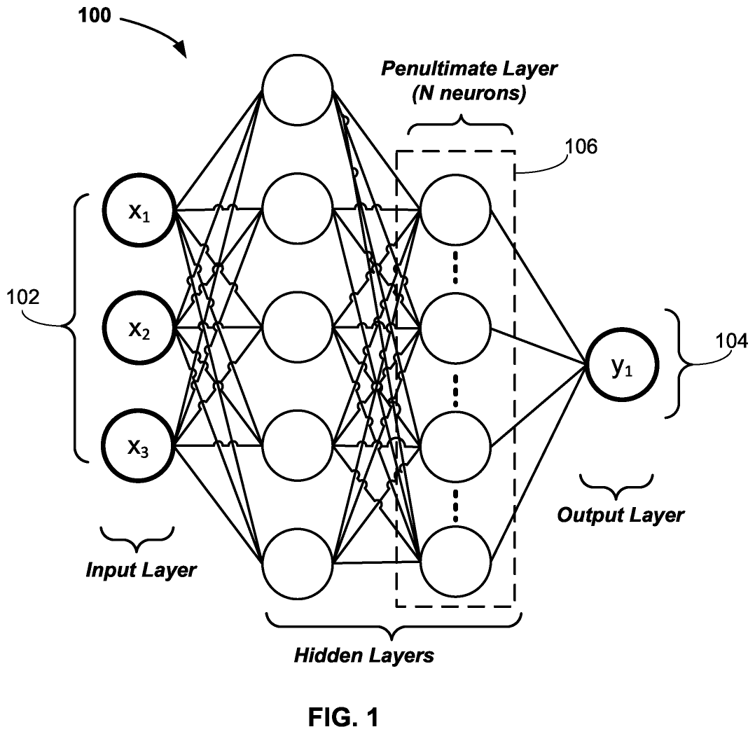

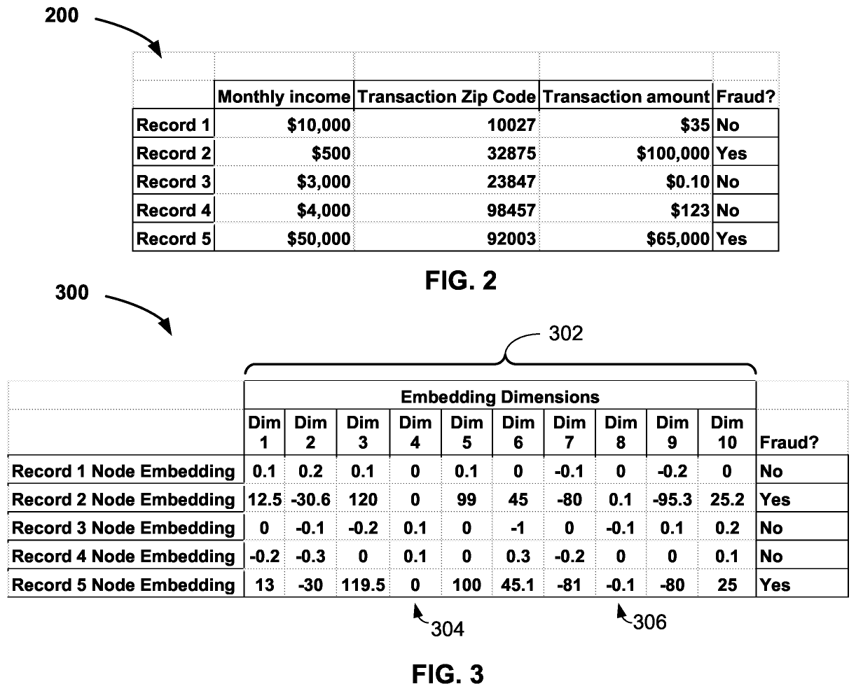

FIG. 1 is an example graph neural network (GNN) 100, which may be utilized to illustrate certain processes of the disclosed technology. This example GNN 100 is not intended to restrict the disclosed technology, but rather, it is illustrated to be consistent with the example spreadsheet and tabular data illustrated in FIG. 2, as will be discussed below. FIGS. 1-3 may be used to illustrate a use case example for how the disclosed technology may be utilized for detecting and/or predicting a fraudulent transaction. Fraud detection, for example may include processes and measures to correctly identify and prevent unauthorized financial activity, which can include identity theft, insurance scams, unauthorized credit card transactions, etc.

The illustrative example GNN 100 shown in FIG. 1 may be characterized as having four layers, including an input layer 102 (having three inputs for this example), an output layer 104 (having one output for this example), and two hidden layers, with the last hidden layer (right before the output layer), denoted as the penultimate layer 106.

In certain exemplary implementations, the layers of the GNN can include neurons having weighted inputs and may be connected to neurons of adjacent layers. However, the neurons of the input layer (such as input layer 102) may be used to introduce information (which may be in the form of vector) into the GNN system, and such input neurons can include non-weighted inputs. However, in certain exemplary implementations, the input neurons can have (or be assigned) input weights. For example, in certain implementations, the input weights of the input neurons can be randomly assigned. In general, the input layer can be utilized to send input information to subsequent layers of the graph neural network, for which the associated neurons can have weighted inputs that can be assigned and/or calculated.

In accordance with certain exemplary implementations of the disclosed technology, a hidden layer in the GNN may be a layer between input layers and output layers, in which the associated neurons may take in a set of weighted inputs and produce an output, for example, through an activation function. Hidden neural network layers may be set up in many different ways. For example, neurons of a hidden layer may have weighted inputs that may initially be randomly assigned. In certain exemplary implementations, the neurons of a hidden layer may be adjusted and/or calibrated, for example, via backpropagation. In certain exemplary implementations, the hidden layer may receive and convert a probabilistic input to an output (for example, based on weights and/or activation functions) for input to the next layer. In accordance with certain exemplary implementations of the disclosed technology, the hidden layers in the graph neural network can be constructed using various neural network approaches, including but not limited to convolutional, recurrent neural, and feedforward neural networks. The output layer in the GNN may include the last layer of neurons that produce given outputs, for example, based on the data present at the input layer and configuration of the hidden layers.

In accordance with certain exemplary implementations of the disclosed technology, the GNN may be trained using a first subset of known training data, which can include known input values applied to the inputs (at the input layer) and known targets (at the output layer). These known inputs and targets of the first subset of the training data may be used to train the GNN, specifically by determining connections (or edges) and weights of the connections among the neurons of the hidden (or inner) layers of the GNN that will produce the known target outputs based on the known inputs. In certain exemplary implementations, training may include assigning random weights to each of the edges, and the output of the model (which may or may not be correct) can be compared to the targets. Backward propagation may be utilized to adjust the weights during the process of training.

FIG. 2 is an example graph data spreadsheet representation of records (rows) with associated inputs (monthly income, zip code, transaction amount) and determined results (fraud or no fraud), according to an exemplary embodiment of the disclosed technology. The example shown in FIG. 2 may represent an original “fraud” dataset.

Returning to the example GNN 100 of FIG. 1, and with reference to the example spreadsheet 200 of FIG. 2, the input layer 102 of the example GNN 100 can include input neurons for which initial input data may be brought into the GNN 100 for further processing by subsequent layers. As illustrated in the example spreadsheet 200 of FIG. 2, input data for the input layer 102 can include a column vector (of five scalar values for this example) corresponding to records of monthly income (for input to the neuron denoted x₁ in FIG. 1), a column vector corresponding to records of the transaction zip code (for input to the neuron denoted x₂ in FIG. 1), and a column vector corresponding to records of the transaction amount for input to the neuron denoted x₃ of FIG. 1).

In certain exemplary implementations, the GNN 100 of FIG. 1 may be trained by using a set of training data. For example, the spreadsheet 200 of FIG. 2 could be used to train the GNN 100 of FIG. 1 by constraining the associated output neurons of the output layer 104 to correspond to known outputs for a set of input records. In this illustrative example, the far right column of the spreadsheet 200 denotes whether a particular record was associated with some type of fraud. As an example, “Record 3” of the spreadsheet 200 shows that fraud (yes) was associated with a customer having a monthly income of $500 and a transaction of $100,000.00, whereas “Record 4” shows that there was no fraud (no) associated with the customer having a $4,000.00 monthly income and a transaction of $123.00. In this example, the output layer 104 may be constrained for training with a vector y₁=[0, 1, 0, 0, 1], where “0” may represent no fraud associated with the transaction, and where “1” may represent fraud associated with the transaction. During training, for example, the weights of the neurons of the hidden layers may be adjusted so that the output will produce y₁, given the inputs x₁, x₂, and x₃.

After the GNN is trained, the outputs can provide a prediction based on the inputs. To evaluate the accuracy of the trained GNN, a second subset of the known training input data may be used for the inputs, and the resulting output(s) may be compared with the target(s) of the second subset of training data.

The hidden layers, and in particular, the penultimate layer, as will be discussed below, may have associated node embeddings that represent the relationship of a single neuron to neighboring neurons for a specific GNN. Such node embeddings may be represented by a vector of N scalar values, with each of the scalar values representing a node embedding dimension, as will be discussed below with reference to FIG. 3.

Even though graphs (such as the GNN 100 illustrated in FIG. 1) may utilize neurons (circles) and edges (lines between nodes) to provide a compact representation of connections among the data inputs, outputs, various features, weights, and/or influences, etc., such graphs can be difficult for a computer processor to interpret and utilize. Certain exemplary implementations of the disclosed technology may utilize a tabular format to capture and/or express the GNN node embedding, which as discussed above, can be a vector that provides information on the neighborhood of the neuron.

FIG. 3 is an example tabular format representation 300 of ten embedding dimensions and associated scalar values associated with a penultimate layer of a GNN. In accordance with certain exemplary implementations of the disclosed technology, the dimensionality of this example representation 300 may be reduced, for example, to include dimension embeddings that strongly correlate or influence the output. An “embedding” as discussed herein, may be a relatively low-dimensional space into which high-dimensional vectors may be mapped. Embeddings may enable machine learning using sparse vectors as inputs. For example, embedding may capture some of the meaning of an input by placing similar inputs close together in an embedding dimension. The example shown in FIG. 3 represents the node embeddings 302 extracted from an example GNN's penultimate layer of neurons (such as from the penultimate layer 106 depicted in FIG. 1). In the example depicted in FIG. 3, there are ten neurons (N=10) in the penultimate layer, so there may be ten embedding dimensions for each one of the records (rows).

The example shown in FIG. 3 is exaggerated to illustrate that the non-fraud record node embeddings 302 may be very close to the origin in the associated (hyper)space, while the fraud records are very far from the origin (and close to each other in that space). Also, as illustrated in FIG. 3, the embedding dimensions DIM4 304 and DIM8 306 may not include scalar embeddings that distinguish between fraud and non-fraud. In accordance with certain exemplary implementations of the disclosed technology, a tree-based model that is trained to map these embedding dimensions 304 and 306 to the fraud label output may not find these embedding dimensions important for prediction. Depending on the chosen threshold for this specific example, it may be determined that eight out of the ten embedding dimensions are useful for prediction (while two are not), and the penultimate layer of the GNN may be revised to have eight neurons instead of ten.

The disclosed technology may be utilized to determine and/or associate importance metric values to embedding dimensions so that those dimensions having an importance metric below a given threshold may be removed before further processing is done. The process disclosed herein enables determining which of the GNN's penultimate layer neurons are best at encoding a graph node's information, and which ones are not as good at encoding the information so that they may be removed. Certain implementations of the disclosed technology may provide the technical benefit of reducing the processing time associated with a neural network by selecting and/or reducing the neural network node embedding dimensionality.

In a typical use or application of the systems and methods disclosed herein, a user may provide several inputs, such as graph data for a node classification or regression task, an original graph neural network with node embeddings extracted from the penultimate layer of the model (which can contain a relatively high number of dimensions), a tree-based machine learning method that can supply feature importance values when trained, and a threshold (for example, between 0 and 1) for node embedding dimension importance and for selection of node embeddings.

In accordance with certain exemplary implementations of the disclosed technology, the system may begin by training the user's supplied graph neural network model on the supplied graph for the node classification or regression task. In certain exemplary implementations, once the neural network training has been completed, node embeddings may be extracted across the entire training graph. In certain exemplary implementations, node embeddings may be extracted from the penultimate layer of the training graph. Then, embedding importances may be determined based on the node embeddings. In certain exemplary implementations, the importances may be extracted from the embeddings by training the user's tree-based machine learning method to map the node embeddings to the node classes or target values. Feature importance values may then be extracted from the tree-based model, which numerically may show the importance of each graph node embedding dimension in predicting the correct node classification or target value.

Due to inherent noise in the training process and subsequent determination of feature importance values, the process may be repeated several times and may have feature importances summed to reduce the reliance upon a single node embedding importance run. In certain exemplary implementations, the system may train the tree-based model and extract node embedding importances by repeating the process by a reasonable or default number of times (for example, 10 times). In other exemplary implementations, the user may specify the number of runs, as desired.

In accordance with certain exemplary implementations of the disclosed technology, once the node embedding importances across all runs are summed, they may then be divided by the maximum importance value. In certain exemplary implementations, it may be preferred to avoid min-max normalization of the importance values to protect relatively important node embedding dimensions in cases where the node embedding importance values are similar. In certain implementations, the node embedding importance values may be represented by a value between 0 and 1.

In accordance with certain exemplary implementations of the disclosed technology, a threshold for node embedding selection may be applied to the importance values such that only the number of dimensions that have importance values over the threshold may be selected and retained. The graph neural network may then be retrained on the original training set with an embedding dimension (number of neurons contained in the penultimate layer of the model) equal to the selected number of dimensions. In certain exemplary implementations, the “reduced dimensionality” trained graph neural network may be returned. Additionally, original and/or subsequent node embedding importance values may be returned for analysis.

In the illustrative example shown in FIG. 3, the rows may represent individual records, and the node embeddings 302 for each node may represent transactions or other interactions, for example, between a customer and a merchant. An input graph, therefore, may include one node (or neuron) for each customer and merchant. In accordance with certain exemplary implementations of the disclosed technology, the node embedding 302 may be a vector of N scalar values representing how the GNN understood (and/or calculated) the relationship of one single neuron to all the others. In accordance with certain exemplary implementations of the disclosed technology, each neuron may have a node embedding that represents how the specific GNN was trained, and this specific embedding may be used to encode or characterize the neighborhood around a neuron.

Through the various systems and processes discussed herein, and as discussed above, the disclosed technology may be utilized to distinguish which of the GNN's neurons are best (or most important) at encoding a graph node's information, and which nodes are not necessarily important for encoding a graph node's information so that the dimensionality of the GNN may be selected or reduced accordingly to improve accuracy, processing speed, and/or data storage requirements.

In accordance with certain exemplary implementations of the disclosed technology, the penultimate layer and its associated dimension's neural embeddings of the GNN may be utilized to distinguish a neuron's importance (or lack thereof) for encoding a graph. In yet other implementations, other hidden layers may be utilized for this purpose.

In accordance with certain exemplary implementations of the disclosed technology, a decision tree model may be utilized to determine (for example, numerically) how important each column of the node embedding 302 was for making its decision (i.e., fraud or no fraud?). In certain exemplary implementations, the decision tree model may output data indicating the importance of each column for making its decision.

In certain exemplary implementations, embeddings (scalar values) from the penultimate layer 106 of the GNN may be input into the decision tree model. The decision tree model may be utilized to determine which columns (values or dimensions) may be useful in deciding the output. Accordingly, a tree-based model may be utilized for analyzing the importance of each neural network embedding dimension (from the penultimate layer) for reducing the number of embedding dimensions that will be useful in a very dense way. In certain implementations, deep hidden layers may be utilized by the tree-based model. Thus, certain implementations include inputting, into the tree-based model, the node embeddings extracted from the neurons in the penultimate layer of the ML model and determining, using the tree-based model, an importance metric of each of the node embedding dimensions from the penultimate layer nodes, which can include one or more of the following steps: processing the tree-based model, summing node embedding dimension importance value outputs of the tree-based model, and filtering the summed outputs to produce highest importance node embedding dimensions from the penultimate layer neurons by applying the importance threshold input to the summed outputs. Then, the penultimate layer neuron count of the ML model may be restricted or reduced to correspond to a number of the highest importance node embedding dimensions. Then, the restricted penultimate layer may be utilized to train the ML model. This process can provide the technical benefit of reducing the processing time associated with a neural network by selecting and/or reducing the neural network node embedding dimensionality.

In accordance with certain exemplary implementations of the disclosed technology, whenever the importance values are summed from the tree-based model, the importance values may be summed across the number of repeated tree-based model iterations that the user may select. For example, if a user selects 5 runs of training the tree method on the extracted node embeddings, the system may return one importance value per embedding dimension per iteration, resulting in 5 importance values for each embedding dimension in total. Then, according to certain implementations, each of these 5 values for each embedding dimension may be summed, giving one accumulated value for each embedding dimension. Then the accumulated importance values may be normalized, and a threshold may be applied.

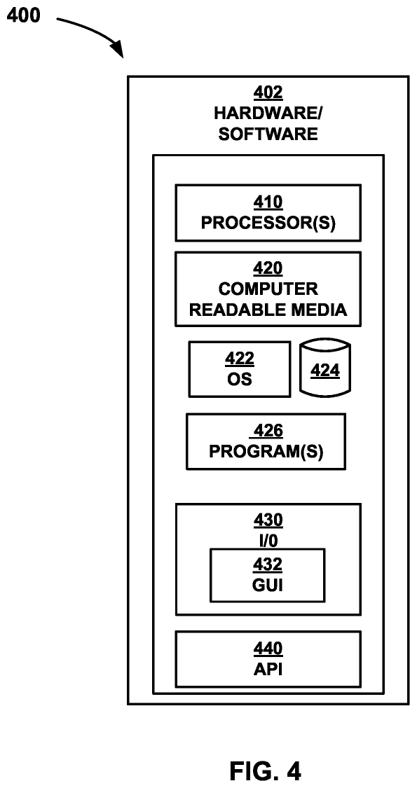

FIG. 4 is a simple block diagram of example hardware and software 402 components that may be utilized according to an aspect of the disclosed technology, which may include one or more of the following: one or more processors 410, a non-transitory computer-readable medium 420, an operating system 422, memory 424, one or more programs 426 including instructions that cause the one or more processors 410 to perform certain functions; an input/output (“I/O”) device 430, and an application program interface (API) 440, among other possibilities. The I/O device 430 may include a graphical user interface 432.

In certain embodiments, the API interface 440 may utilize real-time APIs. In certain aspects, the API may allow a software application, which may be written against the API and installed on a client to exchange data with a server that implements the API in a request-response pattern. In certain embodiments, the request-response pattern defined by the API may be configured synchronously and require that the response be provided in real-time. In some embodiments, a response message from the server to the client through the API consistent with the disclosed embodiments may be in the format including, for example, Extensible Markup Language (XML), JavaScript Object Notation (JSON), and/or the like.

In some embodiments, the API design may also designate specific request methods for a client to access the server. For example, the client may send GET and POST requests with parameters URL-encoded (GET) in the query string or form-encoded (POST) in the body (e.g., a form submission). Alternatively, the client may send GET and POST requests with JSON serialized parameters in the body. Preferably, the requests with JSON serialized parameters use “application/j son” content type. In another aspect, an API design may also require the server to implement the API return messages in JSON format in response to the request calls from the client.

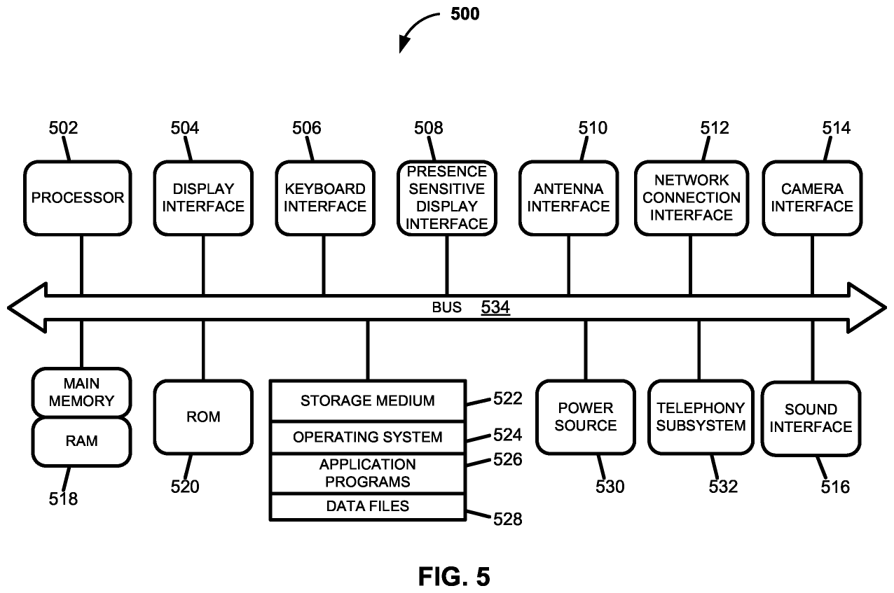

FIG. 5 depicts a block diagram of an illustrative computing device 500 that may be utilized to enable certain aspects of the disclosed technology. Various implementations and methods herein may be embodied in non-transitory computer-readable media for execution by a processor. It will be understood that the computing device 500 may be provided for example purposes only and does not limit the scope of the various implementations of the communication systems and methods.

The computing device 500 of FIG. 5 may include one or more processors where computer instructions may be processed. The computing device 500 may comprise the processor 502, or it may be combined with one or more additional components shown in FIG. 5. In some instances, a computing device may be a processor, controller, or a central processing unit (CPU). In yet other instances, a computing device may be a set of hardware components, such as depicted in FIG. 4.

The computing device 500 may include a display interface 504 that acts as a communication interface and provides functions for rendering video, graphics, images, and texts on the display. In certain example implementations of the disclosed technology, the display interface 504 may be directly connected to a local display. In another example implementation, the display interface 504 may be configured for providing data, images, and other information for an external/remote display. In certain example implementations, the display interface 504 may wirelessly communicate, for example, via a Wi-Fi channel or other available network connection interface 512 to the external/remote display.

In an example implementation, the network connection interface 512 may be configured as a communication interface and may provide functions for rendering video, graphics, images, text, other information, or any combination thereof on the display. For example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 504 may be operatively coupled to a local display. In another example, the display interface 504 may wirelessly communicate, for example, via the network connection interface 512 such as a Wi-Fi transceiver to the external/remote display.

The computing device 500 may include a keyboard interface 506 that provides a communication interface to a keyboard. According to certain example implementations of the disclosed technology, the presence-sensitive display interface 508 may provide a communication interface to various devices such as a pointing device, a touch screen, etc.

The computing device 500 may be configured to use an input device via one or more input/output interfaces (for example, the keyboard interface 506, the display interface 504, the presence-sensitive display interface 508, network connection interface 512, camera interface 514, sound interface 516, etc.,) to allow a user to capture information into the computing device 500. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 500 or may be a separate device. For example, the input device may be an accelerometer, a magnetometer, a digital camera, a microphone, and an optical sensor.

Example implementations of the computing device 500 may include an antenna interface 510 that provides a communication interface to an antenna; a network connection interface 512 that provides a communication interface to a network. According to certain example implementations, the antenna interface 510 may utilize to communicate with a Bluetooth transceiver.

In certain implementations, a camera interface 514 may be provided that acts as a communication interface and provides functions for capturing digital images from a camera. In certain implementations, a sound interface 516 may be provided as a communication interface for converting sound into electrical signals using a microphone and for converting electrical signals into sound using a speaker. According to example implementations, random-access memory (RAM) 518 may be provided, where computer instructions and data may be stored in a volatile memory device for processing by the CPU 502.

According to an example implementation, the computing device 500 may include a read-only memory (ROM) 520 where invariant low-level system code or data for basic system functions such as basic input and output (I/O), startup, or reception of keystrokes from a keyboard may be stored in a non-volatile memory device. According to an example implementation, the computing device 500 may include a storage medium 522 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example implementation, the computing device 500 may include a power source 530 that provides an appropriate alternating current (AC) or direct current (DC) to power components. According to an example implementation, the computing device 500 may include a telephony subsystem 532 that allows the device 500 to transmit and receive sound over a telephone network. The constituent devices and the CPU 502 communicate with each other over a bus 534.

In accordance with an example implementation, the CPU 502 has an appropriate structure to be a computer processor. In one arrangement, the computer CPU 502 may include more than one processing unit. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 to execute software programs. Data may be stored in the RAM 518, where the data may be accessed by the computer CPU 502 during execution. In one example configuration, the device 500 may include at least 128 MB of RAM, and 256 MB of flash memory.

The storage medium 522 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 500 to access computer-executable process steps, application programs, and the like, stored on removable and non-removable memory media, to off-load data from the device 500 or to upload data onto the device 500. A computer program product, such as one utilizing a communication system may be tangibly embodied in storage medium 522, which may comprise a machine-readable storage medium.

According to one example implementation, the term computing device, as used herein, may be a CPU, or conceptualized as a CPU (for example, the CPU 502 of FIG. 5). In this example implementation, the computing device (CPU) may be coupled, connected, and/or in communication with one or more peripheral devices.

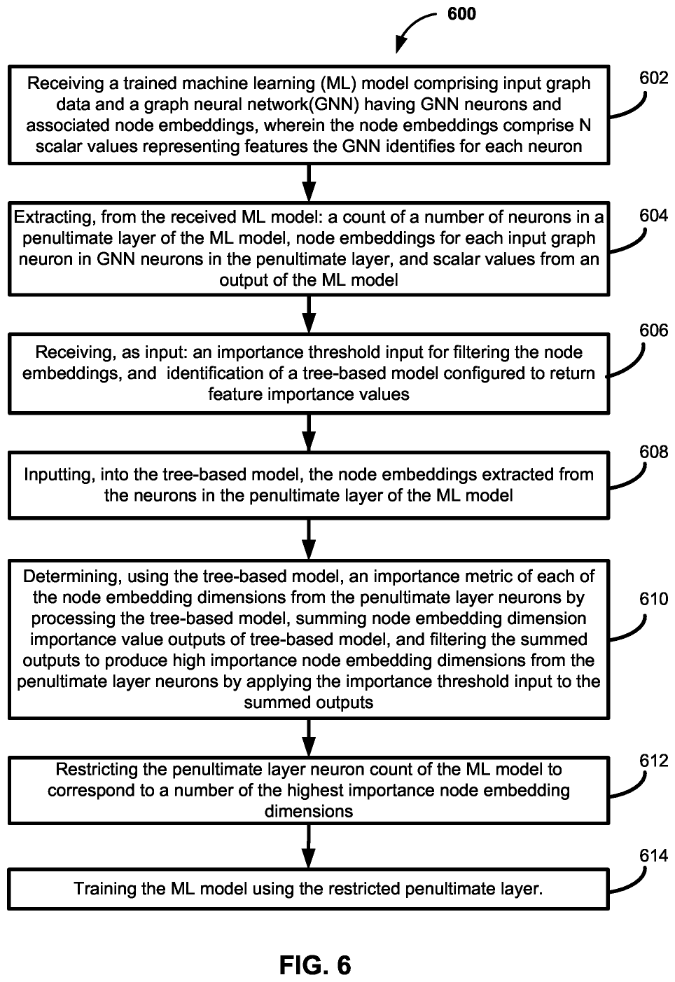

FIG. 6 is a flow diagram of a method 600 according to an exemplary implementation of the disclosed technology. The method 600 may be utilized for reducing or selecting embedding dimensions in a machine learning model.

In block 602, the method 600 can include receiving a trained machine learning (ML) model with input graph data, and a graph neural network (GNN) having GNN neurons and associated node embeddings. For example, the ML model may correspond to, or be represented by a GNN, similar to the GNN 100 shown in FIG. 1 and discussed above. In certain exemplary implementations, the ML model may be represented by a GNN having a number of input layer neurons that correspond with the number of embedding dimensions.

Certain exemplary implementations of the disclosed technology may reduce the embedding dimensions, and as a result, reduce computing resources and/or time to produce predictions (outputs) based on new observations (inputs).

In certain exemplary implementations, the input graph data of the ML model may be represented in tabular form, such as the example tabular format representation 300 shown in FIG. 3 and discussed above. In certain implementations, the node embeddings can include N scalar values representing features the GNN identifies for each neuron.

In block 604, the method 600 can include extracting, from the received ML model, a count of a number of neurons in a penultimate layer of the ML model, node embeddings for each input graph neuron in the GNN penultimate layer, and scalar values from an output of the ML model. For example, using the example tabular format representation 300 shown in FIG. 3, the penultimate layer initially has ten neurons, each neuron corresponding to one of the ten embedding dimensions 302, and each embedding dimension having a corresponding node embeddings. For example, “Dim 4” has associated node embeddings: 0, 0, 0.1, 0.1, 0. Continuing with the example of FIG. 3, the method may extract the scalar values from the output layer, which in this example may be represented by: 0, 1, 0, 0, 1; where “0” represents no fraud, and where “1” represents fraud. In accordance with certain exemplary implementations of the disclosed technology, the node embeddings may be extractable from the GNN's neurons for each node in the input graph.

In block 606, the method 600 can include receiving, as input, an importance threshold input for filtering the node embeddings, and identification of a tree-based model configured to return feature importance values. The importance threshold, for example, may be used as a settable or adjustable parameter that may specify a threshold for filtering-out embedding dimensions that have the least influence on the correct output, and so such embedding dimensions can be removed, essentially placing emphasis on those embedding dimensions that provide more accurate predictions of correct outputs based on observations. In certain exemplary implementations, the importance threshold input may be in a range between 0 and 1.

In certain exemplary implementations, the identified tree-based model may be configured to return feature importance values based on the node embeddings extracted from the neurons in the penultimate layer of the ML model. In certain exemplary implementations, the identified tree-based learning model may be configured to return feature importance values after the tree-based learning model has been trained. In certain exemplary implementations, the tree-based model may be trained to map the extracted node embeddings to one or more classes and/or target values.

In block 608, the method 600 can include inputting, into the tree-based model, the node embeddings extracted from the neurons in the penultimate layer of the ML model.

In block 610, the method 600 can include determining, using the tree-based model, an importance metric of each of the node embedding dimensions from the penultimate layer neurons. For example, FIG. 3 illustrates an exaggerated version of embeddings and associated embedding dimensions in the penultimate layer in which certain embedding dimensions (such as DIM4 304 and DIM8 306) may not be strong indications for distinguishing between a fraud and a non-fraud output. Accordingly, a tree-based model (or another model) trained to map these embedding dimensions to the fraud label output may not find these embedding dimensions important for prediction and may produce a low importance metric for such embedding dimensions.

Continuing in block 610, the determining can include processing the tree-based model, summing node embedding dimension importance value outputs of the tree-based model; and filtering the summed outputs to produce ranked importance node embedding dimensions from the penultimate layer nodes. Certain implementations may further include receiving an integer value specifying repetitions for training the tree-based model and performing a number of runs as specified by the received integer value.

Depending on the chosen importance threshold for filtering the summed outputs, for the example shown in FIG. 3, it may be determined that a portion of embedding dimensions may be useful for prediction, while others may not be useful. By applying the importance threshold input to the summed outputs, node embedding dimensions that have ranked importance node embedding dimension that are lower than the threshold may be eliminated, for example, to reduce computing resource requirements, and/or to increase the corresponding processing speed.

In block 612, the method 600 can include restricting the penultimate layer neuron count of the ML model to correspond to those node embedding dimensions having the ranked importance higher than the importance threshold. Alternatively, the method 600 can remove those neurons from the penultimate layer that have the ranked importance lower than the importance threshold or metric.

In block 614, the method 600 can include training the ML model using the restricted penultimate layer. For example, as discussed above, the ML model (having a reduced count of neurons in the penultimate layer) may be trained on a training dataset (such as the dataset 200 shown in FIG. 2).

Certain exemplary implementations of the disclosed technology may normalize the node embedding dimension importance value outputs of runs of the tree-based model. Certain exemplary implementations of the disclosed technology may filter the summed and normalized outputs to produce ranked importance node embedding dimensions from the penultimate layer neurons by applying the importance threshold input to the summed and normalized outputs.

In certain exemplary implementations, the importance threshold input may be used for filtering the ranked importance node embedding dimensions based on the importance value and/or the determined importance metric.

Certain exemplary implementations of the disclosed technology can further include normalizing the node embedding dimension importance value outputs of runs of the tree-based model.

Certain implementations can include filtering the summed and normalized outputs to produce the highest importance node embedding dimensions from the penultimate layer neurons by applying the importance threshold input to the summed and normalized outputs.

In certain implementations, the node embeddings can include one or more of a neuron identity, an edge identity, and/or the weight of each edge.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general-purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general-purpose machines as computer processing instructions, all or a portion of the functionality of the disclosed embodiments may be implemented instead in dedicated electronics hardware.

The disclosed embodiments also relate to tangible and non-transitory computer-readable media that include program instructions or program code that, when executed by one or more processors, perform one or more computer-implemented operations. The program instructions or program code may include specially designed and constructed instructions or code, and/or instructions and code well-known and available to those having ordinary skills in the computer software arts. For example, the disclosed embodiments may execute high-level and/or low-level software instructions, such as machine code (e.g., such as that produced by a compiler) and/or high-level code that can be executed by a processor using an interpreter.

A peripheral interface may include the hardware, firmware, and/or software that enables communication with various peripheral devices, such as media drives (e.g., magnetic disk, solid-state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high-definition multimedia (HDMI) port, a video port, an audio port, a Bluetooth™ port, a near-field communication (NFC) port, another like communication interface, or any combination thereof.

A mobile network interface may provide access to a cellular network, the Internet, or another wide-area or local area network. In some embodiments, a mobile network interface may include hardware, firmware, and/or software that allows the processor(s) 404 to communicate with other devices via wired or wireless networks, whether local or wide area, private or public, as known in the art. A power source may be configured to provide an appropriate alternating current (AC) or direct current (DC) to power components.

The one or more processors 404 may include one or more of a microprocessor, microcontroller, digital signal processor, co-processor, or the like or combinations thereof capable of executing stored instructions and operating upon stored data. The memory 410 may include one or more suitable types of memory (e.g. such as volatile or non-volatile memory, random access memory (RAM), read-only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data within the memory 410.

The one or more processors 404 may be one or more known processing devices, such as but not limited to, a microprocessor from the Pentium™ family manufactured by Intel™ or the Turion™ family manufactured by AMD™. The one or more processors 410 may constitute a single core or multiple-core processor that executes parallel processes simultaneously. For example, a processor 410 may be a single-core processor that may be configured with virtual processing technologies. In certain embodiments, one or more processors 410 may use logical processors to simultaneously execute and control multiple processes. The one or more processors 410 may implement Virtual Machine technologies, or other similar known technologies to provide the ability to execute, control, run, manipulate, store, etc. multiple software processes, applications, programs, etc. Is should be understood that other types of processor arrangements could be implemented that provide for the capabilities disclosed herein.

In certain exemplary implementations of the disclosed technology, the memory may include one or more memory devices that store data and instructions used to perform one or more features of the disclosed embodiments. The memory may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 410 may include software components that, when executed by one or more processors 404, perform one or more processes consistent with the disclosed embodiments. In some embodiments, the memory may include a database for storing related data to perform one or more of the processes and functionalities associated with the disclosed embodiments.

Following certain exemplary implementations of the disclosed technology, one or more features may be pre-computed and stored for later retrieval and used to provide improvements in processing speeds.

The terms “component,” “module,” “system,” “server,” “processor,” “memory,” and the like may include one or more computer-related units, such as but not limited to hardware, firmware, a combination of hardware and software, software, or software in execution. For example, a component may be but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. Also, these components can execute from various computer readable media having various data structures stored thereon. The components may communicate by way of local and/or remote processes such as by a signal having one or more data packets, such as data from one component interacting with another component in a local system, distributed system, and/or across a network such as the Internet with other systems by way of the signal.

Certain embodiments and implementations of the disclosed technology are described above regarding block and flow diagrams of systems and methods and/or computer program products. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above concerning user devices may include mobile computing devices. Those skilled in the art recognize that there are several categories of mobile devices, generally known as portable computing devices that can run on batteries but are not usually classified as laptops. For example, mobile devices can include but are not limited to portable computers, tablet PCs, internet tablets, PDAs, ultra-mobile PCs (UMPCs), wearable devices, and smartphones. Additionally, implementations of the disclosed technology can be utilized with the internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” and “some implementations,” etc., indicate that the implementation(s) of the disclosed technology so described may include a particular feature, structure, or characteristic, but not every implementation necessarily may include the particular feature, structure, or characteristic. Further, repeated use of the phrase “in one implementation” does not necessarily refer to the same implementation, although it may.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Throughout the specification and the claims, the following terms take at least the meanings explicitly associated herein, unless the context dictates otherwise. The term “connected” means that one function, feature, structure, or characteristic may be directly joined to or in communication with another function, feature, structure, or characteristic. The term “coupled” means that one function, feature, structure, or characteristic may be directly or indirectly joined to or in communication with another function, feature, structure, or characteristic. The term “or” may be intended to mean an inclusive “or.” Further, the terms “a,” “an,” and “the” are intended to mean one or more unless specified otherwise or clear from the context to be directed to a singular form. By “comprising” or “containing” or “including” may be meant that at least the named element, or method step may be present in the article or method but does not exclude the presence of other elements or method steps, even if the other such elements or method steps have the same function as what is named.

While certain embodiments of this disclosure have been described in connection with what may be presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology may be defined in the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXEMPLARY USE CASES

The disclosed technology may be utilized in many use cases, including but not limited to the exemplary use case of fraud determination based on transaction records, as discussed herein with respect to FIG. 2 and FIG. 3.

In another exemplary use case, the disclosed technology may be utilized to provide purchase recommendations for a user or customer based on their available (or derived) information such as (but not limited to) age, gender, location, purchase history, social network interconnections, interests, fields of expertise, work history, etc., and similar available information and purchase histories of other users or customers. Such diverse information may be used to populate a dataset, and the disclosed technology may be utilized to generate, train, and/or refine an efficient machine learning model that may harvest purchase recommendations (based on available data) that may otherwise, be too cumbersome or slow if the associated dimensionality is too high for a given processing system or time constraint.

As discussed with respect to the fraud determination example, a similar process may be used for the purchase recommendation use case. For example, the system disclosed here may utilize several inputs, such as graph data (with the above-referenced available information), an original graph neural network with node embeddings extracted from the penultimate layer of the model, a tree-based machine learning method that can supply feature importance values when trained, and a threshold (for example, between 0 and 1) for node embedding dimension importance and for selection of node embeddings.

The system may begin by training the supplied graph neural network model on the supplied graph data for the node classification. Once the neural network training has been completed, the node embeddings may be extracted from the penultimate layer of the training graph. Then, embedding importances may be determined by using the tree-based model embeddings. For example, the importances of the embeddings may be determined by training the tree-based machine learning method to map the node embeddings to the node classes or target values. Feature importance values may then be extracted from the tree-based model, which numerically may show the importance of each graph node embedding dimension in predicting the correct node classification or target value.

The system may train the tree-based model and extract node embedding importances by repeating the process by a default or selected number of times. The node embedding importances across all runs may be summed and divided by the maximum importance value to normalize the importance values so that they may be represented by a value between 0 and 1. A threshold may be used filter such dimensions so that the system may preserve important node embedding dimensions so that they may be selected and retained.

In certain exemplary implementations, the reduced-dimensional graph neural network may then be retrained on the original training set (i.e., in this use case, known purchase histories of other customers) with an embedding dimension (number of neurons contained in the penultimate layer of the model) equal to the selected number of dimensions. In certain exemplary implementations, the reduced dimensionality trained graph neural network may be returned. In certain instances, the reduced dimensionality trained graph neural network may be evaluated using a different subset to training data. In certain exemplary implementations, the original and/or subsequent node embedding importance values may be returned for analysis.

As discussed in the fraud detection/prediction use case, the purchase recommendation use case may also utilize the embeddings (scalar values) from the penultimate layer of the neural network as input into the decision tree model. The decision tree model may be utilized to determine which columns (values or dimensions) may be useful in deciding the output. The purchase recommendation use case may further include inputting, into the tree-based model, the node embeddings extracted from the nodes in the penultimate layer of the ML model and determining, using the tree-based model, an importance metric of each of the node embedding dimensions from the penultimate layer neurons. This process may include one or more of the following steps:
(1) processing the node embeddings using the tree-based model to determine importance values;
(2) summing the node embedding dimension importance value outputs of the tree-based model;
(3) filtering the summed outputs to produce highest importance node embedding dimensions from the penultimate layer nodes by applying the importance threshold input to the summed outputs;
(4) restricting the penultimate layer node count of the ML model to correspond to a number of the highest importance node embedding dimensions; and
(5) using restricted penultimate layer may to train the ML model.

In the above-reference process, whenever the importance values are summed from the tree-based model, the importance values may be summed across the number of repeated tree-based model iterations that the user may select. For example, if a user selects 10 runs of training the tree method on the extracted node embeddings, the system may return one importance value per embedding dimension per iteration, resulting in 10 importance values for each embedding dimension in total. Then, according to certain implementations, each of these 10 values for each embedding dimension may be summed, giving one accumulated value for each embedding dimension. Then the accumulated importance values may be normalized, and the threshold may be applied. This process can provide the technical benefit of reducing the processing time associated with a neural network by selecting and/or reducing the neural network node embedding dimensionality.

The disclosed technology may enable use cases associated with machine learning and neural network explainability. For example, there has been a long-felt need for providing a comprehensible description of the internal “black box” algorithms, for example, for how a deep neural network transforms data, particularly in cases of high-dimensionality. Certain implementations of the disclosed technology may enable the evaluation and determination of importance metrics of the embedding dimensions in outputting correct predictions, so that for example, embedding dimensions having lower importance may be distinguished from ones having higher importance, and the dimensionality may be adjusted accordingly while gaining insights as to the effect that certain embedding dimensions have on the output. Using such information, an optimum number of values may be determined to restrict the dimensionality of the penultimate layer to this reduced dimensionality, which may be done manually or automatically.

What is claimed is:

1. A computer-implemented method for reducing or selecting embedding dimensions in a machine learning model, the method comprising:
receiving a trained machine learning (ML) model, the ML model comprising input graph data; and
a graph neural network (GNN) having GNN neurons and associated node embeddings, wherein the node embeddings comprise N scalar values representing features the GNN identifies for each neuron;
extracting, from the received ML model:
a count of a number of neurons in a penultimate layer of the ML model;
node embeddings for each input graph node in GNN neurons in penultimate layer nodes; and
scalar values from an output of the ML model;
receiving, as input:
an importance threshold input for filtering the node embeddings; and
identification of a tree-based model configured to return feature importance values;
inputting, into the tree-based model, the node embeddings extracted from the neurons in the penultimate layer of the ML model;
determining, using the tree-based model, an importance metric of each of the node embedding dimensions from the penultimate layer neurons, the determining comprising:
processing the tree-based model;
summing node embedding dimension importance value outputs of the tree-based model; and
filtering the summed outputs to produce highest importance node embedding dimensions from the penultimate layer neurons by applying the importance threshold input to the summed outputs;
restricting the penultimate layer neuron count of the ML model to correspond to a number of the highest importance node embedding dimensions; and
training the ML model using the restricted penultimate layer.

2. The method of claim 1, wherein the node embeddings are extractable from the GNN's neurons for each node in the input graph.

3. The method of claim 1, wherein the importance threshold input comprises a range between 0 and 1.

4. The method of claim 1, wherein the tree-based model is configured to return feature importance values after the tree-based model has been trained.

5. The method of claim 1, wherein the tree-based model is trained to map the node embeddings to one or more of node classes and target values.

6. The method of claim 1, wherein the importance threshold input for filtering the node embeddings is based on the determined importance metric.

7. The method of claim 1, further comprising: receiving an integer value specifying repetitions for training the tree-based model.

8. The method of claim 7, wherein processing the tree-based model comprises performing a number of runs as specified by the received integer value.

9. The method of claim 1, further comprising normalizing the node embedding dimension importance value outputs of runs of the tree-based model.

10. The method of claim 9, further comprising filtering the summed and normalized outputs to produce highest importance node embedding dimensions from the penultimate layer neurons by applying the importance threshold input to the summed and normalized outputs.

11. The method of claim 1, wherein the node embeddings include a neuron identity, an edge identity, and a weight of each edge.

12. A system, comprising:
a processor; and
memory comprising instructions that when executed by the processor cause the processor to:
extract, from a machine learning (ML) model:
a count of a number of neurons in a penultimate layer of the ML model;
node embeddings for each input graph node in graph neural network (GNN) neurons in the penultimate layer of the ML model; and
scalar values from an output of the ML model;
determine, using a tree-based model, an importance metric of at least one embedding dimension of node embeddings from the penultimate layer neurons, comprising:
processing a tree-based model;
summing node embedding dimension importance value outputs of the tree-based model; and
filtering the summed outputs to produce high importance node embedding dimensions from penultimate layer nodes by applying an importance threshold input to the summed node embedding dimension importance value outputs;
restrict the penultimate layer node count of the ML model to correspond to a number of the high importance node embedding dimensions; and
train the ML model using the restricted penultimate layer.

13. The system of claim 12, wherein the node embeddings are extractable from the GNN's nodes for each node in the input graph.

14. The system of claim 12, wherein the importance threshold input comprises a range between 0 and 1.

15. The system of claim 12, wherein the tree-based model is configured to return feature importance values after the tree-based model has been trained.

16. The system of claim 12, wherein the tree-based model is trained to map the node embeddings to one or more of node classes and target values.

17. The system of claim 12, wherein the importance threshold input for filtering the node embeddings is based on the determined importance metric.

18. The system of claim 12, wherein the system is further configured to process the tree-based model by performing a number of runs as specified by a received integer value specifying repetitions for training the tree-based model.

19. The system of claim 12, wherein the system is further configured to normalize the node embedding dimension importance value outputs of runs of the tree-based model and filter the summed and normalized outputs to produce high importance node embedding dimensions from penultimate layer nodes by applying the importance threshold input to the summed and normalized outputs.

20. At least one non-transitory computer-readable medium comprising a set of instructions that, in response to being executed by a processor circuit, cause the processor circuit to:
determine, using a tree-based model, an importance metric of each dimension of node embeddings from penultimate layer neurons of a trained graph neural network (GNN), the determining comprising: summing node embedding dimension importance value outputs of the tree-based model, and filtering the summed node embedding dimension importance value outputs by applying an importance threshold input to produce high importance node embedding dimensions associated with the penultimate layer neurons;
restrict the penultimate layer node to correspond to the high importance node embedding dimensions; and
train a machine learning model associated with the GNN using the restricted penultimate layer.
